(19) United States
(12) Patent Application Publication
(10) Pub. No.: US 2017/0182503 A1
(43) Pub. Date: Jun. 29, 2017

(54) SPRAY DEVICES AND UNITARILY FORMED COMPONENTS THEREOF

(71) Applicant: Moen Incorporated, North Olmsted, OH (US)

(72) Inventors: Thomas D. Moehring, Brunswick, OH (US); James J. Sposit, Sagamore Hills, OH (US)

(21) Appl. No.: 15/390,390

(22) Filed: Dec. 23, 2016

Related U.S. Application Data
(60) Provisional application No. 62/272,303, filed on Dec. 29, 2015.

(51) Int. Cl. B05B 1/16; B05B 3/04; B05B 12/00; B05B 1/30; B05B 1/18

(52) U.S. Cl. CPC B05B 1/1636; B05B 1/30; B05B 1/18; B05B 12/002; B05B 3/0422

(57) ABSTRACT

The present invention provides spray devices for plumbing fixture fittings and unitarily formed components thereof having complex flow paths, made of multiple materials, and/or that are movable.

### CROSS-REFERENCE TO RELATED APPLICATION

This application claims the benefit of U.S. Provisional Application No. 62/272,303, filed Dec. 29, 2015, the entire disclosure of which is hereby incorporated by reference.

### FIELD

The present invention relates generally to spray devices and unitarily formed components thereof, and, more particularly, to spray devices for plumbing fixture fittings and unitarily formed components thereof having complex flow paths, made of multiple materials, and/or that are movable.

### BACKGROUND

Spray devices for plumbing fixture fittings, such as side sprays and shower heads, are known. Spray devices for plumbing fixture fittings and components thereof having complex flow paths, made of multiple materials, and/or that are movable can be difficult to manufacture.

### SUMMARY

The present invention provides spray devices for plumbing fixture fittings and waterways and spray faces for spray devices for plumbing fixture fittings.

In an exemplary embodiment, a spray device includes a waterway, a shell, a spray face, a first valve body, a second valve body, and an actuator. The waterway has an outer surface. The waterway includes an inlet port, a first cavity, a first flow path, a first outlet port, a second cavity, a second flow path, and a second outlet port. The inlet port has an inlet opening in the outer surface. The inlet port is in fluid communication with the first cavity and the second cavity. The first cavity has a first cavity opening in the outer surface. The first cavity is in fluid communication with the first flow path. The second cavity has a second cavity opening in the outer surface. The second cavity is in fluid communication with the second flow path. The first flow path is in fluid communication with the first outlet port. The first outlet port has a first outlet opening in the outer surface. The second flow path is in fluid communication with the second outlet port. The second outlet port has a second outlet opening in the outer surface. The first flow path is not in fluid communication with the second flow path. The waterway is operable to have fluid flow from the inlet port to the first outlet port and the second outlet port. The shell is hollow. The shell has an inlet opening, an actuator opening, and an outlet opening. The spray face includes a first spray portion and a second spray portion. The first outlet port is in fluid communication with the first spray portion. The second outlet port is in fluid communication with the second spray portion. The first valve body is operable to control fluid flow from the inlet port to the first outlet port. The second valve body is operable to control fluid flow from the inlet port to the second outlet port. The actuator is operable to connect to the first valve body and the second valve body through the actuator opening. The shell is operable to receive the waterway. The first cavity in the waterway is operable to receive the first valve body through the first cavity opening, and the second cavity in the waterway is operable to receive the second valve body through the second cavity opening. The first valve body is operable to move within the first cavity, and the second valve body is operable to move within the second cavity. The actuator is operable to move the first valve body within the first cavity, and the actuator is operable to move the second valve body within the second cavity. Movement of the first valve body within the first cavity opens and closes fluid flow between the inlet port and the first outlet port, and movement of the second valve body within the second cavity opens and closes fluid flow between the inlet port and the second outlet. The first cavity opening has a central tangent line that passes through a center point of the first cavity opening and is tangent to a central longitudinal axis of the first flow path. The first outlet opening has a central tangent line that passes through a center point of the first outlet opening and is tangent to the central longitudinal axis of the first flow path. The first flow path includes a portion that is not parallel to and not tangent to at least one of the central tangent line of the first cavity opening and the central tangent line of the first outlet opening. The central tangent line of the first cavity opening is not parallel to the central tangent line of the first outlet opening. The waterway is unitarily formed.

In an exemplary embodiment, a spray device includes a waterway, a shell, a spray face, a valve body, and an actuator. The waterway has an outer surface. The waterway includes an inlet port, a flow path, a cavity, and an outlet port. The inlet port has an inlet opening in the outer surface. The inlet port is in fluid communication with the flow path. The flow path is in fluid communication with the cavity. The cavity has a cavity opening in the outer surface. The flow path is in fluid communication with the outlet port. The outlet port has an outlet opening in the outer surface. The waterway is operable to have fluid flow from the inlet port to the outlet port. The shell is hollow. The shell has an inlet opening, an actuator opening, and an outlet opening. The spray face includes a spray portion. The outlet port is in fluid communication with the spray portion. The valve body is operable to control fluid flow from the inlet port to the outlet port. The actuator is operable to connect to the valve body through the actuator opening. The shell is operable to receive the waterway. The cavity in the waterway is operable to receive the valve body through the cavity opening. The valve body is operable to move within the cavity. The actuator is operable to move the valve body within the cavity. Movement of the valve body within the cavity opens and closes fluid flow between the inlet port and the outlet port. The spray portion has an outer surface. The spray portion includes an inlet port, a flow path, and an outlet port. The inlet port has an inlet opening in the outer surface. The flow path extends from the inlet port to the outlet port. The outlet port has an outlet opening in the outer surface. The outlet port has a central longitudinal axis that passes through a center point of the outlet opening. The outlet port is converging. At least one of the flow path from the inlet port to the outlet port includes an obstruction and the central longitudinal axis of the outlet port does not pass through the inlet opening. The spray face is unitarily formed.

In an exemplary embodiment, a spray device includes a waterway, a shell, a spray face, a valve body, and an actuator. The waterway has an outer surface. The waterway includes an inlet port, a flow path, a cavity, and an outlet port. The inlet port has an inlet opening in the outer surface. The inlet port is in fluid communication with the flow path. The flow path is in fluid communication with the cavity. The cavity has a cavity opening in the outer surface. The flow path is in fluid communication with the outlet port. The outlet port has an outlet opening in the outer surface. The waterway is operable to have fluid flow from the inlet port to the outlet port. The shell is hollow. The shell has an inlet opening, an actuator opening, and an outlet opening. The spray face includes a spray portion. The outlet port is in fluid communication with the spray portion. The valve body is operable to control fluid flow from the inlet port to the outlet port. The actuator is operable to connect to the valve body through the actuator opening. The shell is operable to receive the waterway. The cavity in the waterway is operable to receive the valve body through the cavity opening. The valve body is operable to move within the cavity. The actuator is operable to move the valve body within the cavity. Movement of the valve body within the cavity opens and closes fluid flow between the inlet port and the outlet port. The spray portion includes a body and a nozzle. The body is formed from a first material. The nozzle is formed from a second material. The first material is different than the second material. The spray face, including the body and the nozzle, is unitarily formed. At least a portion of the body is concurrently formed with the nozzle.

In an exemplary embodiment, a spray device includes a manifold, a spray assembly, and a spray face. The manifold includes an inlet and an outlet. The inlet is in fluid communication with the outlet. The spray assembly includes a rear plate, a flow diverter plate, a spray former plate, and a front plate. The rear plate includes a first opening, a first chamber, a second opening, and a second chamber. The first opening is operable to fluidly communicate with the outlet of the manifold. The first opening is in fluid communication with the first chamber. The second opening is operable to fluidly communicate with the outlet of the manifold. The second opening is in fluid communication with the second chamber. The flow diverter plate includes a first channel and a second channel. The first channel is in fluid communication with the first chamber. The second channel is in fluid communication with the second chamber. The spray former plate includes a plurality of nozzles. The nozzles of the spray former plate are in fluid communication with one of the first channel and the second channel. The front plate includes a plurality of nozzles and a plurality of openings. The nozzles of the front plate are in fluid communication with the other of the first channel and the second channel. The openings of the front plate are operable to receive the nozzles of the spray former plate. The spray face includes a plurality of openings. The openings in the spray face are operable to receive the nozzles of the spray former plate and the nozzles of the front plate. The spray former plate is formed from a first material. The front plate is formed from a second material. The first material is different than the second material. The spray assembly, including the rear plate, the flow diverter plate, the spray former plate, and the front plate, is unitarily formed. At least a portion of the spray former plate is concurrently formed with at least a portion of the front plate.

In an exemplary embodiment, a spray device includes a manifold, a spray assembly, and a spray face. The manifold includes an inlet and an outlet. The inlet is in fluid communication with the outlet. The spray assembly includes a rear plate, a flow diverter plate, a turbine, a spray former plate, and a front plate. The rear plate includes a first opening, a first chamber, a second opening, and a second chamber. The first opening is operable to fluidly communicate with the outlet of the manifold. The first opening is in fluid communication with the first chamber. The second opening is operable to fluidly communicate with the outlet of the manifold. The second opening is in fluid communication with the second chamber. The flow diverter plate includes a first channel and a second channel. The first channel is in fluid communication with the first chamber. The second channel is in fluid communication with the second chamber. The turbine includes a plurality of vanes. The turbine is in fluid communication with one of the first channel and the second channel. The spray former plate includes a plurality of nozzles. The nozzles of the spray former plate are in fluid communication with the other of the first channel and the second channel. The front plate includes a plurality of nozzles and a plurality of openings. The nozzles of the front plate are in fluid communication with the turbine. The openings of the front plate are operable to receive the nozzles of the spray former plate. The spray face includes a plurality of openings. The openings in the spray face are operable to receive the nozzles of the spray former plate and the nozzles of the front plate. The turbine is operable to rotate within the spray assembly. The spray assembly, including the rear plate, the flow diverter plate, the spray former plate, and the front plate, is unitarily formed. At least a portion of the turbine is concurrently formed with at least a portion of the spray former plate and at least a portion of the front plate.

In an exemplary embodiment, a waterway includes an inlet port, a first cavity, a first flow path, a first outlet port, a second cavity, a second flow path, and a second outlet port. The inlet port has an inlet opening in an outer surface of the waterway. The inlet port is in fluid communication with the first cavity. The first cavity has a first cavity opening in the outer surface. The first cavity is in fluid communication with the first flow path. The first flow path is in fluid communication with the first outlet port. The first outlet port has a first outlet opening in the outer surface. The inlet port is in fluid communication with the second cavity. The second cavity has a second cavity opening in the outer surface. The second cavity is in fluid communication with the second flow path. The first flow path is not in fluid communication with the second flow path. The second flow path is in fluid communication with the second outlet port. The second outlet port has a second outlet opening in the outer surface. The waterway is operable to have fluid flow from the inlet port to the first outlet port and the second outlet port. The first cavity opening has a central tangent line that passes through a center point of the first cavity opening and is tangent to a central longitudinal axis of the first flow path. The first outlet opening has a central tangent line that passes through a center point of the first outlet opening and is tangent to the central longitudinal axis of the first flow path. The first flow path includes a portion that is not parallel to and not tangent to at least one of the central tangent line of the first cavity opening and the central tangent line of the first outlet opening. The central tangent line of the first cavity opening is not parallel to the central tangent line of the first outlet opening. The waterway is unitarily formed.

In an exemplary embodiment, a spray face includes a spray portion. The spray portion has an outer surface. The spray portion includes an inlet port, a flow path, and an outlet port. The inlet port has an inlet opening in the outer surface. The flow path extends from the inlet port to the outlet port. The outlet port has an outlet opening in the outer surface. The outlet port has a central longitudinal axis that passes through a center point of the outlet opening. The outlet port is converging. At least one of the flow path from the inlet port to the outlet port includes an obstruction and the central longitudinal axis of the outlet port does not pass through the inlet opening. The spray face is unitarily formed.

In an exemplary embodiment, a spray face includes a spray portion. The spray portion includes a body and a nozzle. The body is formed from a first material. The nozzle is formed from a second material. The first material is different than the second material. The spray face, including the body and the nozzle, is unitarily formed. At least a portion of the body is concurrently formed with the nozzle.

### BRIEF DESCRIPTION OF THE DRAWINGS

FIG. 1 is a perspective view of a side spray according to an exemplary embodiment of the present invention;

FIG. 2 is an exploded perspective view of the side spray of FIG. 1, including a waterway, a shell, a spray face, valve bodies, and an actuator;

FIG. 3 is an exploded perspective view of the waterway and the valve bodies of FIGS. 1-2;

FIG. 4 is a perspective view of the waterway of FIG. 3;

FIG. 5 is a side elevational view of the waterway of FIG. 3;

FIG. 6 is a top plan view of the waterway of FIG. 3;

FIG. 7 is a side cross-sectional view of the waterway of FIG. 3 taken along the line A-A in FIG. 6;

FIG. 8 is a top cross-sectional view of the waterway of FIG. 3 taken along the line B-B in FIG. 5;

FIG. 9 is a perspective view of the spray face of FIGS. 1-2;

FIGS. 10a-10f include views of another exemplary waterway for use in a side spray of the present invention—FIG. 10a is a perspective view, FIG. 10b is a side elevational view, FIG. 10c is a side cross-sectional view taken along the line A-A in FIG. 10b, FIG. 10d is a side cross-sectional view taken along the line B-B in FIG. 10b, FIG. 10e is a side cross-sectional view taken along the line C-C in FIG. 10b, and FIG. 10f is a side cross-sectional view taken along the line D-D in FIG. 10b;

FIGS. 11a-11g include cross-sectional sketches of flow paths through a waterway—FIGS. 11a-11d include sketches of flow paths through a waterway of the present invention, and FIGS. 11e-11g include sketches of flow paths through waterways not covered by the present invention;

FIGS. 12a-12c include views of another exemplary spray face for use in a side spray of the present invention—FIG. 12a is a perspective view, FIG. 12b is a top plan view, and FIG. 12c is a side cross-sectional view taken along the line A-A in FIG. 12b;

FIGS. 13a-13d include sketches of spray portions of a spray face of the present invention;

FIG. 14 is a perspective cross-sectional view of another exemplary spray face for use in a side spray of the present invention;

FIG. 15 is a perspective view of a shower head according to an exemplary embodiment of the present invention;

FIG. 16 is an exploded perspective view of the shower head of FIG. 15, including a manifold, a shell, a spray assembly, and a spray face;

FIG. 17 is an exploded perspective view of the spray assembly of FIGS. 15-16, including a rear plate, a flow diverter plate, a turbine, a spray former plate, and a front plate;

FIGS. 18a-18b are views of the rear plate of FIG. 17-FIG. 18a is a rear or upstream view, and FIG. 18b is a front or downstream view; and

FIGS. 19a-19b are views of the flow diverter plate of FIG. 17-FIG. 19a is a rear or upstream view, and FIG. 19b is a front or downstream view.

### DETAILED DESCRIPTION

The present invention provides spray devices for plumbing fixture fittings and unitarily formed components thereof having complex flow paths, made of multiple materials, and/or that are movable. In exemplary embodiments, the spray devices are side sprays and shower heads. However, one of ordinary skill in the art will appreciate that the spray devices could be any spray devices (such as wands and body sprays) for any plumbing fixture fittings (such as faucets and shower systems).

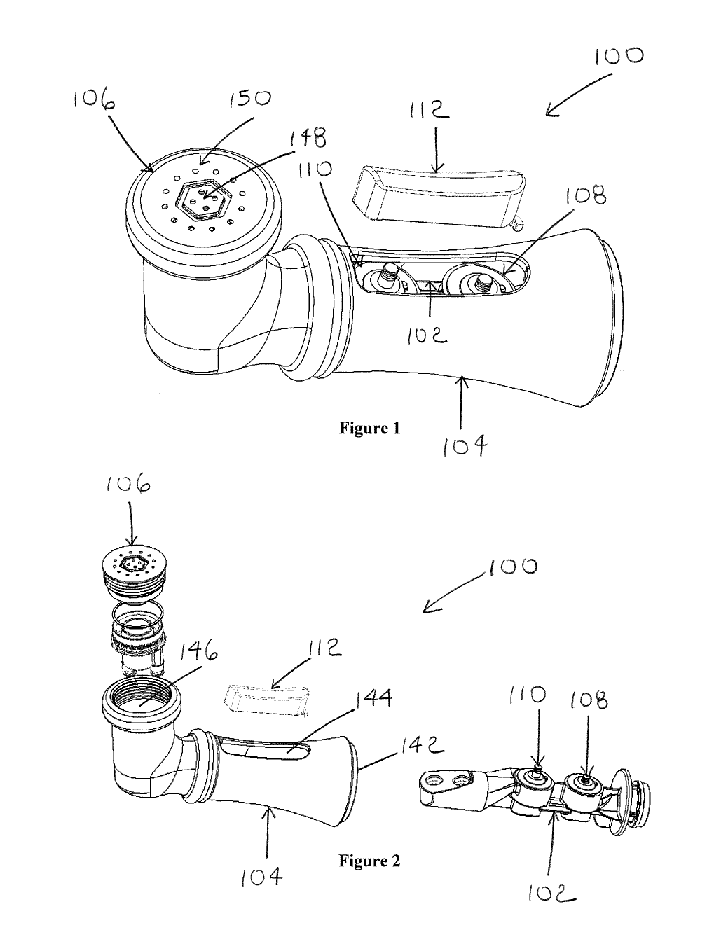

An exemplary embodiment of a side spray 100 of the present invention is shown in FIGS. 1-2. In the illustrated embodiment of FIGS. 1-2, the side spray 100 includes a waterway 102, a shell 104, a spray face 106, a first valve body 108, a second valve body 110, and an actuator 112.

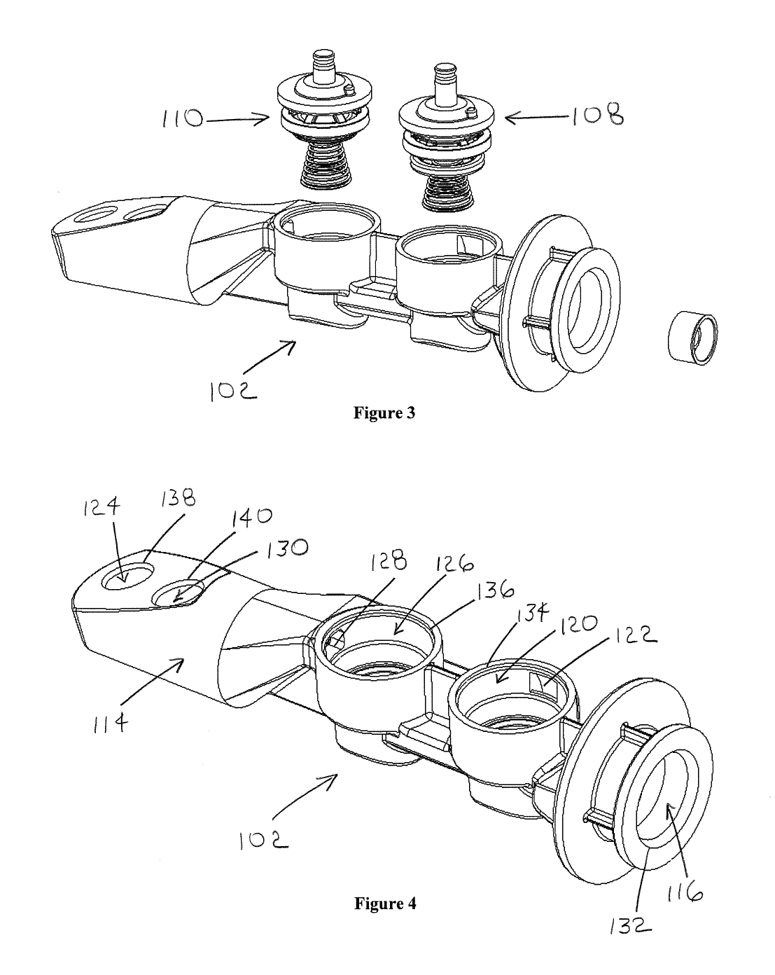

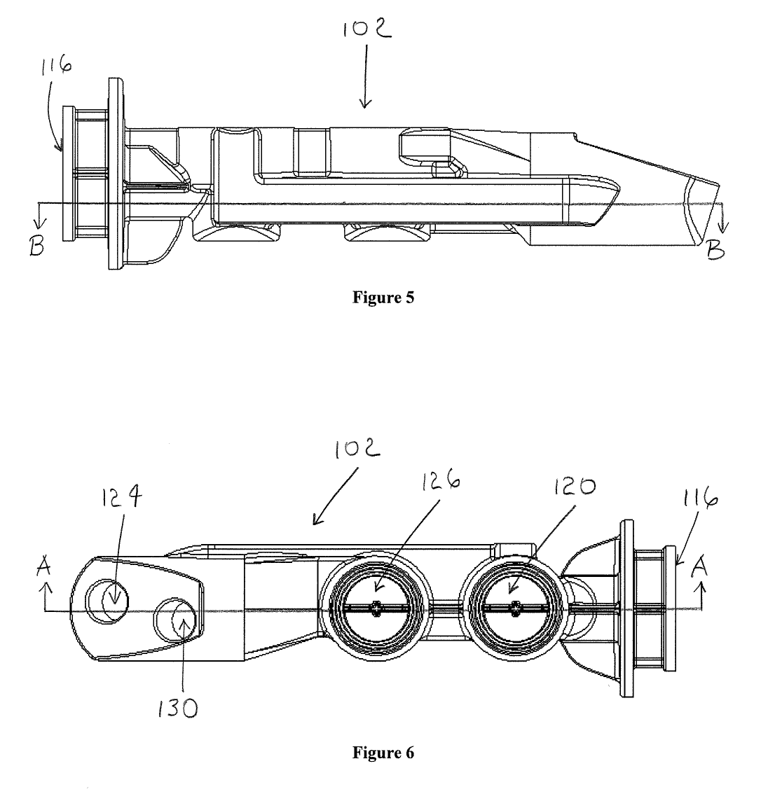

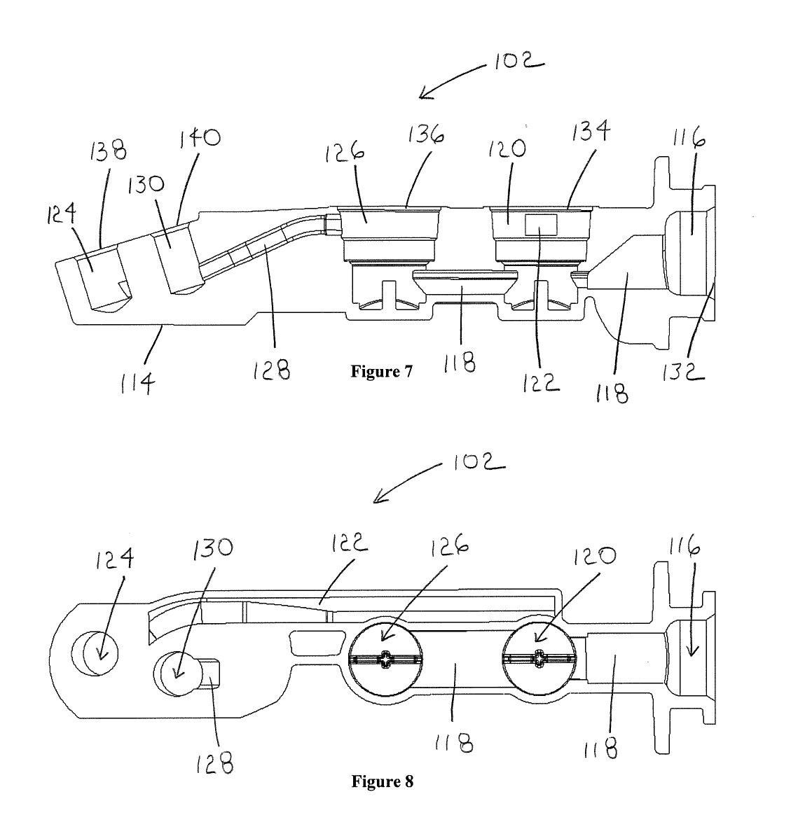

An exemplary embodiment of the waterway 102 is shown in detail in FIGS. 3-8. The waterway 102 has an outer surface 114. In the illustrated embodiment, the waterway 102 includes an inlet port 116, a reservoir 118, a first cavity 120, a first flow path 122, a first outlet port 124, a second cavity 126, a second flow path 128, and a second outlet port 130. The inlet port 116 has an inlet opening 132 in the outer surface 114. The inlet port 116 is in fluid communication with the reservoir 118. The reservoir 118 is in fluid communication with the first cavity 120 and the second cavity 126. The first cavity 120 has a first cavity opening 134 in the outer surface 114. The first cavity 120 is in fluid communication with the first flow path 122. The second cavity 126 has a second cavity opening 136 in the outer surface 114. The second cavity 126 is in fluid communication with the second flow path 128. The first flow path 122 is in fluid communication with the first outlet port 124. The first outlet port 124 has a first outlet opening 138 in the outer surface 114. The second flow path 128 is in fluid communication with the second outlet port 130. The second outlet port 130 has a second outlet opening 140 in the outer surface 114. The first flow path 122 is not in fluid communication with the second flow path 128. The waterway 102 is operable to have fluid flow from the inlet port 116 to the first outlet port 124 and the second outlet port 130. In an exemplary embodiment, the waterway 102 is unitarily formed. In an exemplary embodiment, the waterway 102 is formed of a rigid plastic.

An exemplary embodiment of the shell 104 is shown in detail in FIGS. 1-2. The shell 104 is hollow. In the illustrated embodiment, the shell 104 has an inlet opening 142, an actuator opening 144, and an outlet opening 146. The shell 104 is operable to receive the waterway 102.

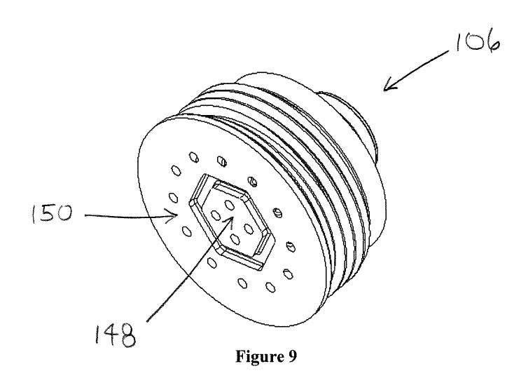

An exemplary embodiment of the spray face 106 is shown in detail in FIGS. 1-2 and 9. In the illustrated embodiment, the spray face 106 includes a first spray portion 148 and a second spray portion 150. The first outlet port 124 is in fluid communication with the first spray portion 148. The second outlet port 130 is in fluid communication with the second spray portion 150. In an exemplary embodiment, the spray face 106 is unitarily formed. In an exemplary embodiment, the spray face 106 is formed of a rigid plastic. In an exemplary embodiment, the spray face 106 is formed of a rigid plastic and an elastomer.

An exemplary embodiment of the first valve body 108 is shown in detail in FIGS. 1-3. In the illustrated embodiment, the first valve body 108 is operable to control fluid flow from the inlet port 116 to the first outlet port 124. The first cavity 120 in the waterway 102 is operable to receive the first valve body 108 through the first cavity opening 134. The first valve body 108 is operable to move within the first cavity 120.

An exemplary embodiment of the second valve body 110 is shown in detail in FIGS. 1-3. In the illustrated embodiment, the second valve body 110 is operable to control fluid flow from the inlet port 116 to the second outlet port 130. The second cavity 126 in the waterway 102 is operable to receive the second valve body 110 through the second cavity opening 136. The second valve body 110 is operable to move within the second cavity 126.

An exemplary embodiment of the actuator 112 is shown in detail in FIGS. 1-2. In the illustrated embodiment, the actuator 112 is operable to connect to the first valve body 108 and the second valve body 110 through the actuator opening 144. The actuator 112 is operable to move the first valve body 108 within the first cavity 120. The actuator 112 is operable to move the second valve body 110 within the second cavity 126. Movement of the first valve body 108 within the first cavity 120 opens and closes fluid flow between the inlet port 116 and the first outlet port 124. Movement of the second valve body 110 within the second cavity 126 opens and closes fluid flow between the inlet port 116 and the second outlet port 130.

Although the side spray 100 has been illustrated as including components with specific structure, one of ordinary skill in the art will appreciate that the components of the side spray 100 could have different structure. For example, the side spray 100 has been illustrated as having: (1) a waterway 102 including a reservoir 118, first and second cavities 120, 126, first and second flow paths 122, 128, and first and second outlet ports 124, 130, (2) a spray face 106 including first and second spray portions 148, 150, and (3) first and second valve bodies 108, 110. However, one of ordinary skill in the art will appreciate that the side spray 100 could have: (1) a waterway without a reservoir and with more or less than two cavities, flow paths, and outlet ports, (2) a spray face with more or less than two spray portions, and (3) more or less than two valve bodies.

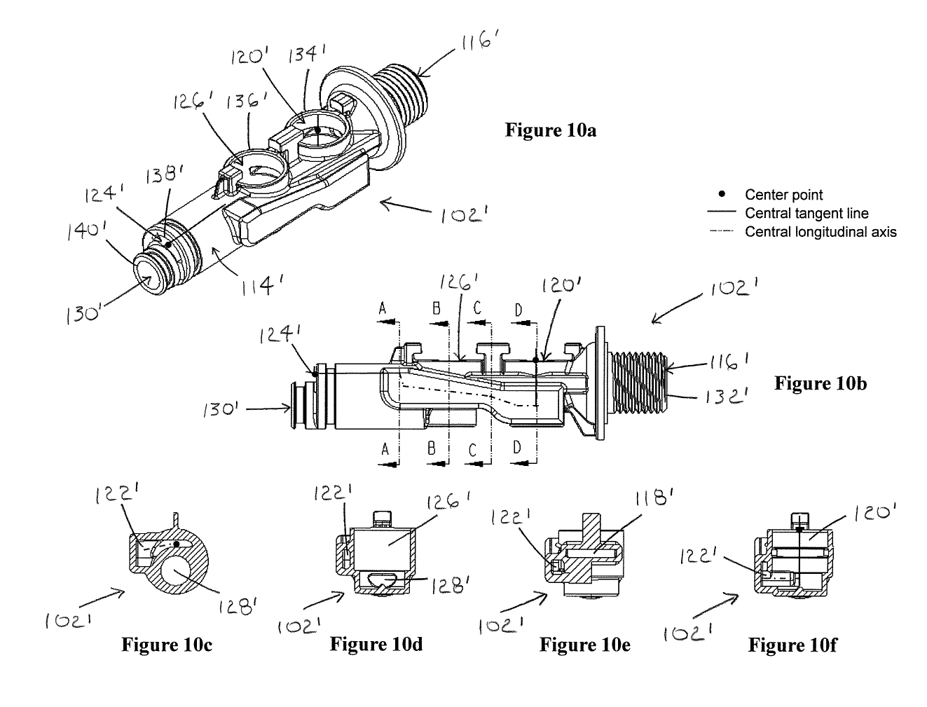

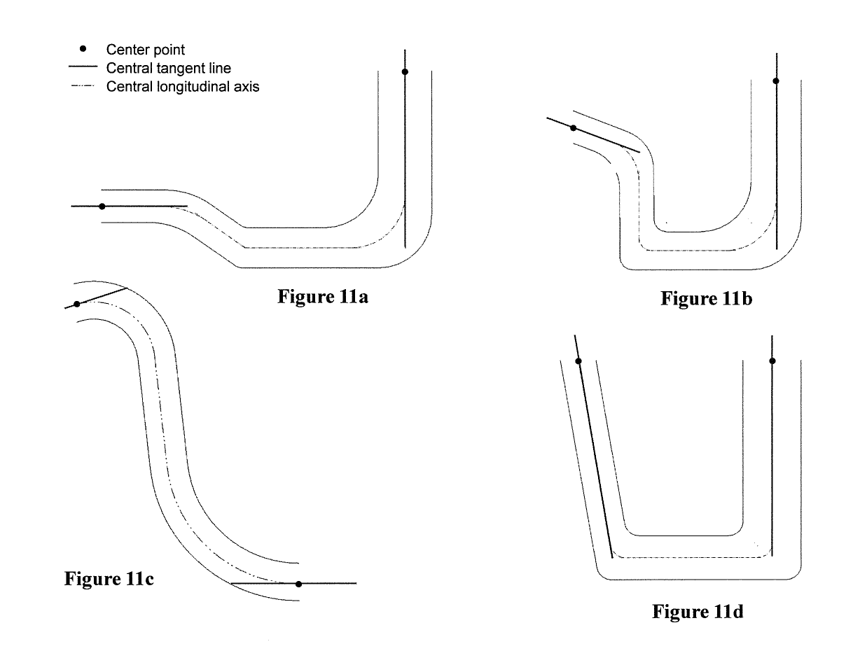

An exemplary embodiment of another waterway 102′ is shown in detail in FIGS. 10a-10f. Although FIGS. 10a-10b are not cross-sectional views, various points, lines, and axes have been shown in these views in the locations where they would be in cross-sectional views for illustration purposes. The waterway 102′ has an outer surface 114′. In the illustrated embodiment, the waterway 102′ includes an inlet port 116′, a reservoir 118′, a first cavity 120′, a first flow path 122′, a first outlet port 124′, a second cavity 126′, a second flow path 128′, and a second outlet port 130′. The inlet port 116′ has an inlet opening 132′ in the outer surface 114′. The inlet port 116′ is in fluid communication with the reservoir 118′. The reservoir 118′ is in fluid communication with the first cavity 120′ and the second cavity 126′. The first cavity 120′ has a first cavity opening 134′ in the outer surface 114′. The first cavity 120′ is in fluid communication with the first flow path 122′. The second cavity 126′ has a second cavity opening 136′ in the outer surface 114′. The second cavity 126′ is in fluid communication with the second flow path 128′. The first flow path 122′ is in fluid communication with the first outlet port 124′. The first outlet port 124′ has a first outlet opening 138′ in the outer surface 114′. The second flow path 128′ is in fluid communication with the second outlet port 130′. The second outlet port 130′ has a second outlet opening 140′ in the outer surface 114′. The first flow path 122′ is not in fluid communication with the second flow path 128′. The waterway 102′ is operable to have fluid flow from the inlet port 116′ to the first outlet port 124′ and the second outlet port 130′. In an exemplary embodiment, the waterway 102′ is unitarily formed. In an exemplary embodiment, the waterway 102′ is formed of a rigid plastic.

In exemplary embodiments of waterways, such as the waterway 102 and the waterway 102′, the first cavity opening 134, 134′ has a central tangent line that passes through a center point of the first cavity opening 134, 134′ and is tangent to a central longitudinal axis of the first flow path 122, 122′. The first outlet opening 138, 138′ has a central tangent line that passes through a center point of the first outlet opening 138, 138′ and is tangent to the central longitudinal axis of the first flow path 122, 122′. The first flow path 122, 122′ includes a portion that is not parallel to and not tangent to at least one of: (1) the central tangent line of the first cavity opening 134, 134′, and (2) the central tangent line of the first outlet opening 138, 138′. The central tangent line of the first cavity opening 134, 134′ is not parallel to the central tangent line of the first outlet opening 138, 138′. In the exemplary embodiments, the waterway 102, 102′ is unitarily formed.

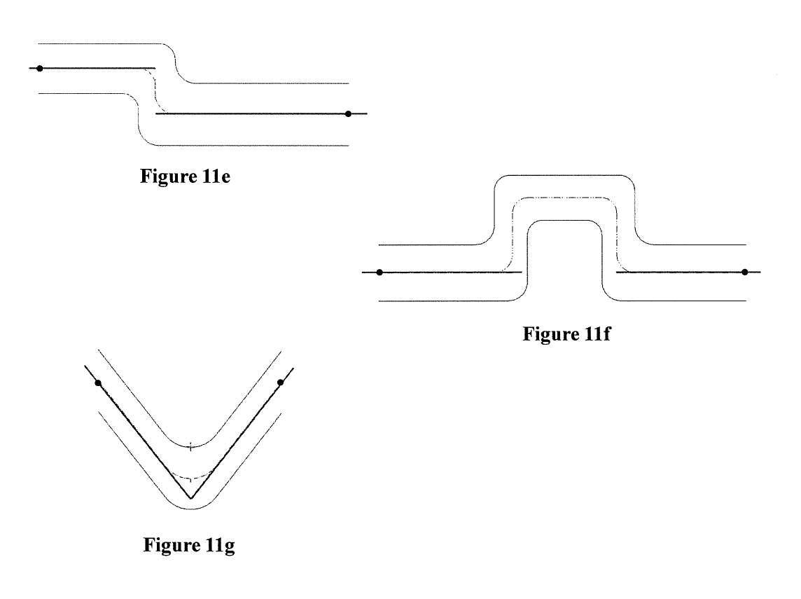

Exemplary embodiments of flow paths, such as the first flow path 122, 122′ and the second flow path 128, 128′ in the waterway 102, 102′, are sketched in FIGS. 11a-11d. Exemplary embodiments of flow paths not covered by the present invention are sketched in FIGS. 11e-11g. Each sketch extends from a cavity opening, such as first cavity opening 134, 134′ in first flow path 122, 122′ and second cavity opening 136, 136′ in second flow path 128, 128′, to an outlet opening, such as first outlet opening 138, 138′ in first flow path 122, 122′ and second outlet opening 140, 140′ in second flow path 128, 128′. In the sketches, either opening could be the cavity opening and either opening could be the outlet opening so the openings have not been labeled. These sketches illustrate: (1) when a portion of the flow path is not parallel to and not tangent to at least one of the central tangent line of the cavity opening and the central tangent line of the outlet opening, and (2) when the central tangent line of the cavity opening is not parallel to the central tangent line of the outlet opening.

In FIGS. 11a-11d, a portion of the flow path is not parallel to and not tangent to at least one of the central tangent line of the cavity opening and the central tangent line of the outlet opening, and the central tangent line of the cavity opening is not parallel to the central tangent line of the outlet opening. In FIGS. 11e-11f, a portion of the flow path is not parallel to and not tangent to at least one of the central tangent line of the cavity opening and the central tangent line of the outlet opening, but the central tangent line of the cavity opening is parallel to the central tangent line of the outlet opening. In FIG. 11g, the central tangent line of the cavity opening is not parallel to the central tangent line of the outlet opening, but there is no portion of the flow path that is not parallel to and not tangent to at least one of the central tangent line of the cavity opening and the central tangent line of the outlet opening.

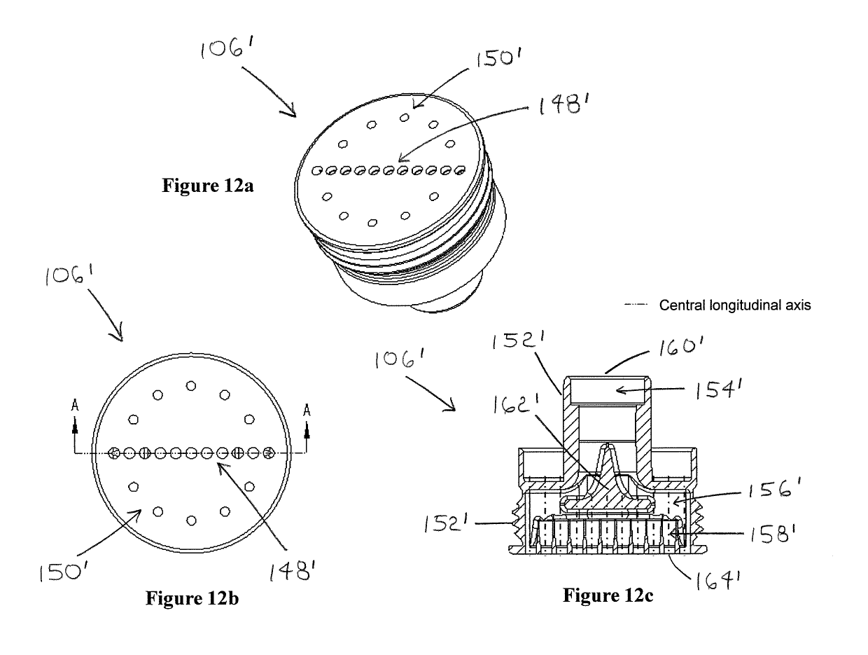

An exemplary embodiment of another spray face 106′ is shown in detail in FIGS. 12a-12c. In the illustrated embodiment, the spray face 106′ includes a first spray portion 148′ and a second spray portion 150′. A first outlet port of a waterway is in fluid communication with the first spray portion 148′. A second outlet port of the waterway is in fluid communication with the second spray portion 150′. The first spray portion 148′ has an outer surface 152′. The first spray portion 148′ includes an inlet port 154′, a flow path 156′, and a plurality of outlet ports 158′. The inlet port 154′ has an inlet opening 160′ in the outer surface 152′. The flow path 156′ extends from the inlet port 154′ to the plurality of outlet ports 158′. The flow path 156′ includes an obstruction 162′ in the flow path 156′. Each of the outlet ports 158′ has an outlet opening 164′ in the outer surface 152′. Each of the outlet ports 158′ has a central longitudinal axis that passes through a center point of the outlet opening 164′. At least one of the outlet ports 158′ is converging. For at least one of the outlet ports 158′, at least one of: (1) the flow path 156′ from the inlet port 154′ to the outlet port 158′ includes an obstruction, such as the obstruction 162′, and (2) the central longitudinal axis of the outlet port 158′ does not pass through the inlet opening 160′. In an exemplary embodiment, the spray face 106′ is unitarily formed. In an exemplary embodiment, the spray face 106′ is formed of a rigid plastic. In an exemplary embodiment, the spray face 106′ is formed of a rigid plastic and an elastomer.

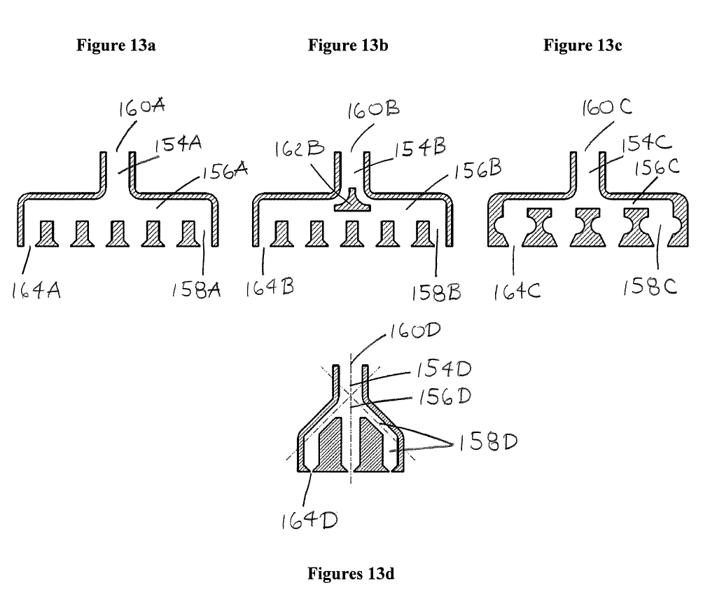

Exemplary embodiments of spray portions, such as the first spray portion 148, 148′ and the second spray portion 150, 150′ of the spray face 106, 106′, are sketched in FIGS. 13a-13d. In the sketches, the same reference numbers in combination with different letters will be used to identify the different embodiments. A reference number in combination with the letter X will be used to generically identify all embodiments. Each sketch extends from an inlet opening 160X in an inlet port 154X, such as the inlet opening 160′ in the inlet port 154′ of the first spray portion 148′ of the spray face 106′, through a flow path 156X, such as the flow path 156′ in the first spray portion 148′ of the spray face 106′, to an outlet opening 164X in an outlet port 158X, such as the outlet opening 164′ in the outlet port 158′ of the first spray portion 148′ of the spray face 106′. These sketches illustrate: (1) when the outlet port 158X is converging, (2) when the flow path 156X from the inlet port 154X to the outlet port 158X includes an obstruction, such as the obstruction 162X, and (3) when the central longitudinal axis of the outlet port 158X does not pass through the inlet opening 160X. In exemplary embodiments, each spray portion sketched in FIGS. 13a-13d is unitarily formed.

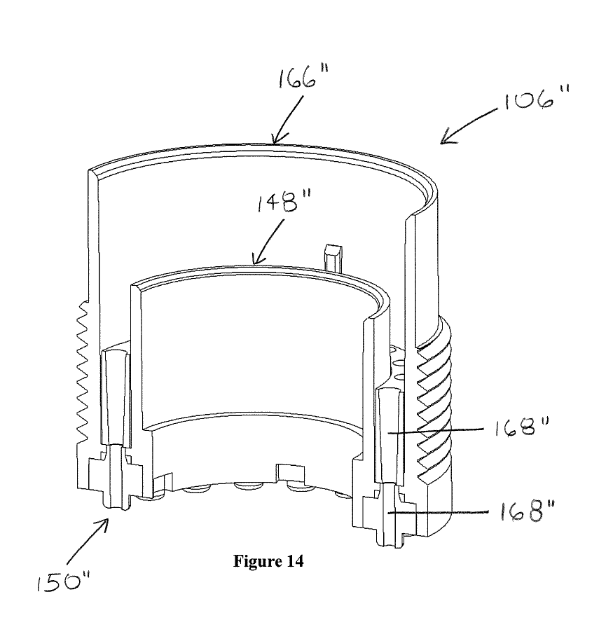

An exemplary embodiment of another spray face 106″ is shown in detail in FIG. 14. In the illustrated embodiment, the spray face 106″ includes a first spray portion 148″ and a second spray portion 150″. A first outlet port of a waterway is in fluid communication with the first spray portion 148″. A second outlet port of the waterway is in fluid communication with the second spray portion 150″. The second spray portion 150″ includes a body 166″ and a plurality of nozzles 168″. The body 166″ is formed from a first material. At least one of the plurality of nozzles 168″ is formed from a second material. In an exemplary embodiment, the first material is different than the second material. In an exemplary embodiment, the spray face 106″, including the body 166″ and the plurality of nozzles 168″, is unitarily formed. In the exemplary embodiment, at least a portion of the body 166″ is concurrently formed with the plurality of nozzles 168″. In an exemplary embodiment, the body 166″ is formed of a rigid plastic. In an exemplary embodiment, at least one of the plurality of nozzles 168″ is formed of an elastomer.

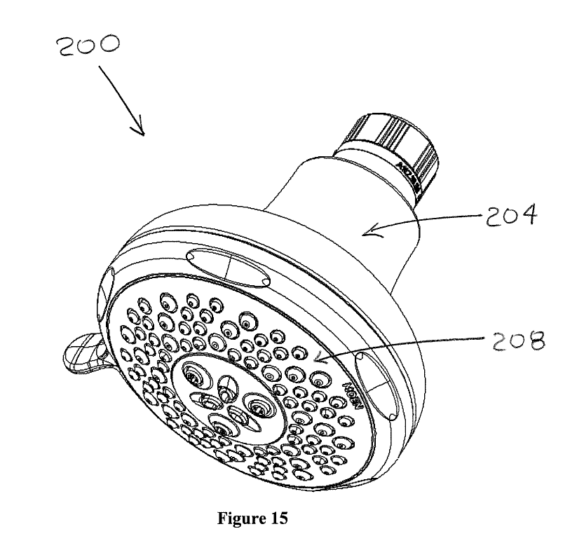

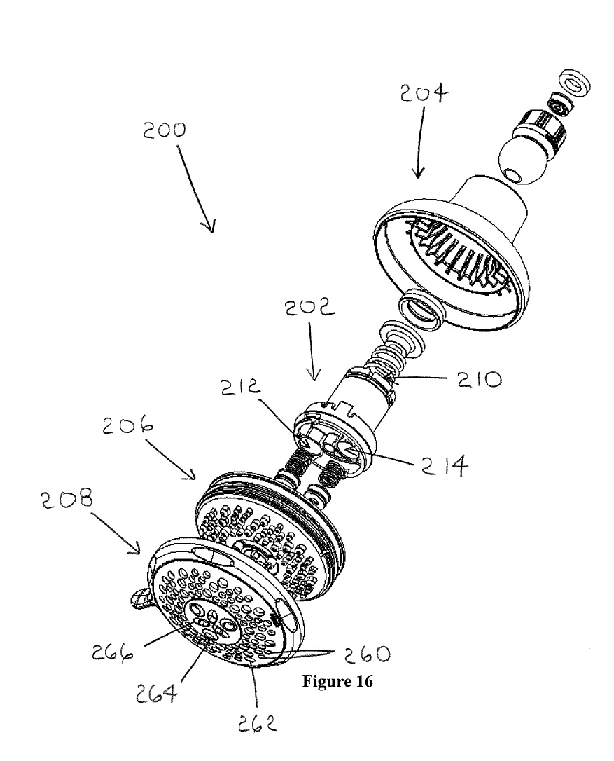

An exemplary embodiment of a shower head 200 of the present invention is shown in FIGS. 15-16. In the illustrated embodiment, the shower head 200 includes a manifold 202, a shell 204, a spray assembly 206, and a spray face 208.

An exemplary embodiment of the manifold 202 is shown in detail in FIG. 16. In the illustrated embodiment, the manifold 202 includes an inlet 210, a first outlet 212, and a second outlet 214. The inlet 210 is in fluid communication with the first outlet 212 and the second outlet 214.

An exemplary embodiment of the shell 204 is shown in detail in FIGS. 15-16. The shell 204 is hollow. In the illustrated embodiment, the shell 204 is operable to receive the manifold 202.

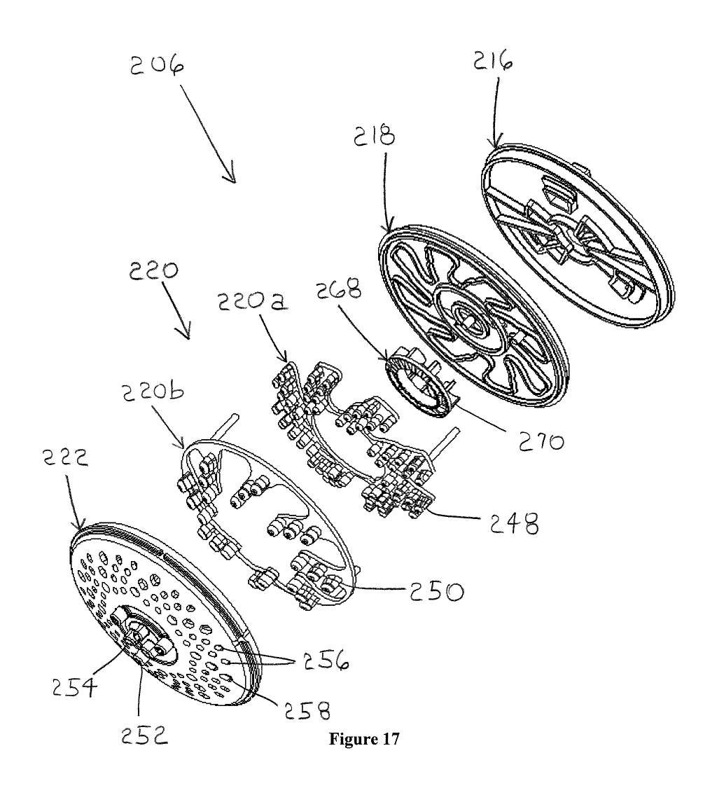

An exemplary embodiment of the spray assembly 206 is shown in detail in FIGS. 16-17. In the illustrated embodiment, the spray assembly 206 includes a rear plate 216, a flow diverter plate 218, a spray former plate 220, and a front plate 222.

An exemplary embodiment of the rear plate 216 is shown in detail in FIGS. 17 and 18a-18b. In the illustrated embodiment, the rear plate 216 includes an upstream side 216u and a downstream side 216d. The upstream side 216u of the rear plate 216 includes two first openings 224, two second openings 226, two third openings 228, and two fourth openings 230. The downstream side 216d of the rear plate 216 includes two first chambers 232a, two second chambers 234a, two third chambers 236a, and a fourth chamber 238a. The first openings 224 in the upstream side 216u of the rear plate 216 are operable to fluidly communicate with the first outlet 212 and the second outlet 214 of the manifold 202. The first openings 224 in the upstream side 216u of the rear plate 216 are in fluid communication with the first chambers 232a on the downstream side 216d of the rear plate 216. The second openings 226 in the upstream side 216u of the rear plate 216 are operable to fluidly communicate with the first outlet 212 and the second outlet 214 of the manifold 202. The second openings 226 in the upstream side 216u of the rear plate 216 are in fluid communication with the second chambers 234a on the downstream side 216d of the rear plate 216. The third openings 228 in the upstream side 216u of the rear plate 216 are operable to fluidly communicate with the first outlet 212 and the second outlet 214 of the manifold 202. The third openings 228 in the upstream side 216u of the rear plate 216 are in fluid communication with the third chambers 236a on the downstream side 216d of the rear plate 216. The fourth openings 230 in the upstream side 216u of the rear plate 216 are operable to fluidly communicate with the first outlet 212 and the second outlet 214 of the manifold 202. The fourth openings 230 in the upstream side 216u of the rear plate 216 are in fluid communication with the fourth chamber 238a on the downstream side 216d of the rear plate 216. In an exemplary embodiment, the rear plate 216 is formed of a rigid plastic.

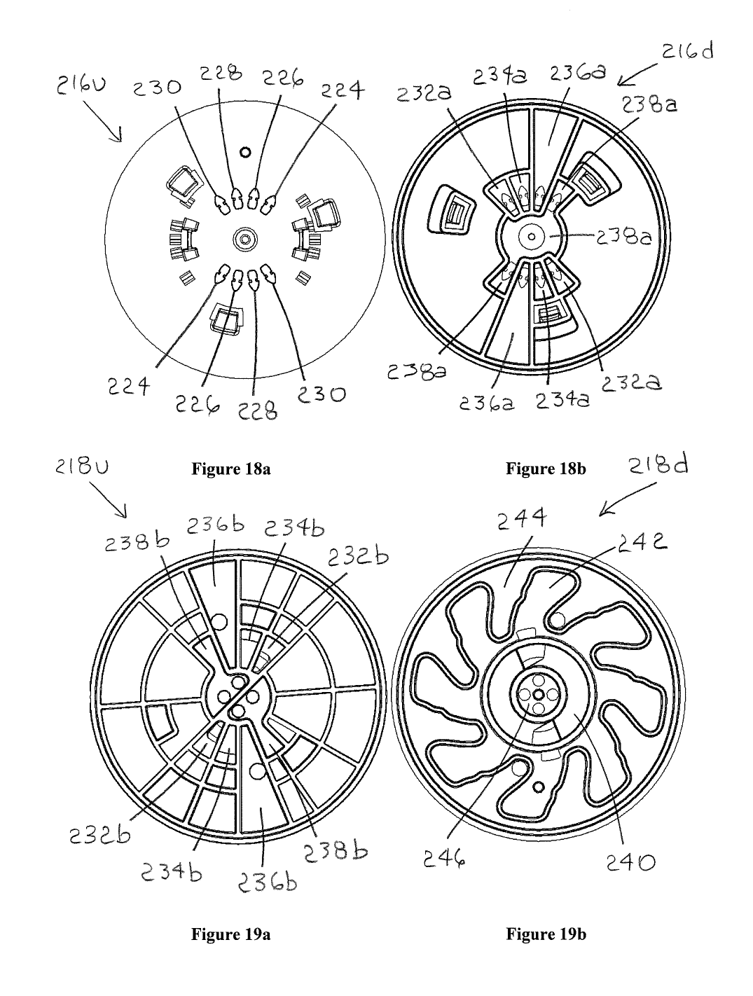

An exemplary embodiment of the flow diverter plate 218 is shown in detail in FIGS. 17 and 19a-19b. In the illustrated embodiment, the flow diverter plate 218 includes an upstream side 218u and a downstream side 218d. The upstream side 218u of the flow diverter plate 218 includes two first chambers 232b, two second chambers, 234b, two third chambers 236b, and a fourth chamber 238b. The downstream side 218d of the flow diverter plate 218 includes a first channel 240, a second channel, 242, a third channel 244, and a fourth channel 246. The first chambers 232b on the upstream side 218u of the flow diverter plate 218 are operable to fluidly communicate with the first chambers 232a on the downstream side 216d of the rear plate 216. The first chambers 232b on the upstream side 218u of the flow diverter plate 218 are in fluid communication with the first channel 240 on the downstream side 218d of the flow diverter plate 218. The second chambers 234b on the upstream side 218u of the flow diverter plate 218 are operable to fluidly communicate with the second chambers 234a on the downstream side 216d of the rear plate 216. The second chambers 234b on the upstream side 218u of the flow diverter plate 218 are in fluid communication with the second channel 242 on the downstream side 218d of the flow diverter plate 218. The third chambers 236b on the upstream side 218u of the flow diverter plate 218 are operable to fluidly communicate with the third chambers 236a on the downstream side 216d of the rear plate 216. The third chambers 236b on the upstream side 218u of the flow diverter plate 218 are in fluid communication with the third channel 244 on the downstream side 218d of the flow diverter plate 218. The fourth chamber 238b on the upstream side 218u of the flow diverter plate 218 is operable to fluidly communicate with the fourth chamber 238a on the downstream side 216d of the rear plate 216. The fourth chamber 238b on the upstream side 218u of the flow diverter plate 218 is in fluid communication with the fourth channel 246 on the downstream side 218d of the flow diverter plate 218. In an exemplary embodiment, the flow diverter plate 218 is formed of a rigid plastic.

An exemplary embodiment of the spray former plate 220 is shown in detail in FIG. 17. In the illustrated embodiment, the spray former plate 220 includes a first spray former plate portion 220a and a second spray former plate portion 220b. The first spray former plate portion 220a includes a first plurality of nozzles 248. The second spray former plate portion 220b includes a second plurality of nozzles 250. The first plurality of nozzles 248 on the first spray former plate portion 220a of the spray former plate 220 are in fluid communication with the second channel 242 on the downstream side 218d of the flow diverter plate 218. The second plurality of nozzles 250 on the second spray former plate portion 220b of the spray former plate 220 are in fluid communication with the third channel 244 on the downstream side 218d of the flow diverter plate 218. In an exemplary embodiment, the spray former plate 220, including the first spray former plate portion 220a and the second spray former plate portion 220b, is formed of a flexible elastomer.

An exemplary embodiment of the front plate 222 is shown in detail in FIGS. 16-17. In the illustrated embodiment, the front plate 222 includes a third plurality of nozzles 252, a fourth plurality of nozzles 254, a first plurality of openings 256, and a second plurality of openings 258. The third plurality of nozzles 252 on the front plate 222 are in fluid communication with the first channel 240 on the downstream side 218d of the flow diverter plate 218. The fourth plurality of nozzles 254 on the front plate 222 are in fluid communication with the fourth channel 246 on the downstream side 218d of the flow diverter plate 218. The first plurality of openings 256 in the front plate 222 are operable to receive the first plurality of nozzles 248 on the first spray former plate portion 220a of the spray former plate 220. The second plurality of openings 258 in the front plate 222 are operable to receive the second plurality of nozzles 250 on the second spray former plate portion 220b of the spray former plate 220. In an exemplary embodiment, the front plate 222 is formed of a rigid plastic.

An exemplary embodiment of the spray face 208 is shown in detail in FIGS. 15-16. In the illustrated embodiment, the spray face 208 includes a first plurality of openings 260, a second plurality of openings 262, a third plurality of openings 264, and a fourth plurality of openings 266. The first plurality of openings 260 in the spray face 208 are operable to receive the first plurality of nozzles 248 on the first spray former plate portion 220a of the spray former plate 220. The second plurality of openings 262 in the spray face 208 are operable to receive the second plurality of nozzles 250 on the second spray former plate portion 220b of the spray former plate 220. The third plurality of openings 264 in the spray face 208 are operable to receive the third plurality of nozzles 252 on the front plate 222. The fourth plurality of openings 266 in the spray face 208 are operable to receive the fourth plurality of nozzles 254 on the front plate 222. In an exemplary embodiment, the spray face 208 is formed of a rigid plastic.

In the illustrated embodiment, the shower head 200 includes a first flow path, a second flow path, a third flow path, and a fourth flow path. The first flow path extends from the first openings 224 in the upstream side 216u of the rear plate 216, to the first chambers 232a on the downstream side 216d of the rear plate 216, to the first chambers 232b on the upstream side 218u of the flow diverter plate 218, to the first channel 240 on the downstream side 218d of the flow diverter plate 218, through the turbine 268, and through the third plurality of nozzles 252 on the front plate 222. The second flow path extends from the second openings 226 in the upstream side 216u of the rear plate 216, to the second chambers 234a on the downstream side 216d of the rear plate 216, to the second chambers 234b on the upstream side 218u of the flow diverter plate 218, to the second channel 242 on the downstream side 218d of the flow diverter plate 218, and through the first plurality of nozzles 248 on the first spray former plate portion 220a of the spray former plate 220. The third flow path extends from the third openings 228 in the upstream side 216u of the rear plate 216, to the third chambers 236a on the downstream side 216d of the rear plate 216, to the third chambers 236b on the upstream side 218u of the flow diverter plate 218, to the third channel 244 on the downstream side 218d of the flow diverter plate 218, and through the second plurality of nozzles 250 on the second spray former plate portion 220b of the spray former plate 220. The fourth flow path extends from the fourth openings 230 in the upstream side 216u of the rear plate 216, to the fourth chamber 238a on the downstream side 216d of the rear plate 216, to the fourth chamber 238b on the upstream side 218u of the flow diverter plate 218, to the fourth channel 246 on the downstream side 218d of the flow diverter plate 218, and through the fourth plurality of nozzles 254 on the front plate 222. Each of the first flow path, the second flow path, the third flow path, and the fourth flow path is not in fluid communication with any of the other of the first flow path, the second flow path, the third flow path, and the fourth flow path.

In an exemplary embodiment, the shower head 200 includes a plurality of flow paths. In the exemplary embodiment, each of the flow paths is not in fluid communication with any of the other of the flow paths. In an exemplary embodiment, the shower head 200 includes a first flow path and a second flow path. In the exemplary embodiment, the first flow path is not in fluid communication with the second flow path.

In an exemplary embodiment, the spray former plate 220 is formed from a first material. The front plate 222 is formed from a second material. In an exemplary embodiment, the first material is different than the second material. In an exemplary embodiment, the spray assembly 206, including the rear plate 216, the flow diverter plate 218, the spray former plate 220, and the front plate 222, is unitarily formed. In an exemplary embodiment, at least a portion of the spray former plate 220 is concurrently formed with at least a portion of the front plate 222.

In an exemplary embodiment, the spray assembly 206 includes a turbine 268. The turbine 268 includes a plurality of vanes 270. The turbine 268 is in fluid communication with the first channel 240 on the downstream side 218d of the flow diverter plate 218. The third plurality of nozzles 252 of the front plate 222 are in fluid communication with the turbine 268. The turbine 268 is operable to rotate within the spray assembly 206. In an exemplary embodiment, the spray assembly 206, including the rear plate 216, the flow diverter plate 218, the spray former plate 220, and the front plate 222, is unitarily formed. In the exemplary embodiment, at least a portion of the turbine 268 is concurrently formed with at least a portion of the spray former plate 220 and at least a portion of the front plate 222. In the exemplary embodiment, the turbine 268 is formed within the spray assembly 206. In an exemplary embodiment, the turbine 268 is formed of a rigid plastic.

Although the shower head 200 has been illustrated as including components with specific structure, one of ordinary skill in the art will appreciate that the components of the shower head 200 could have different structure. For example, the shower head 200 has been illustrated as having: (1) a rear plate 216 including first, second, third, and fourth openings 224, 226, 228, 230, and first, second, third, and fourth chambers 232a, 234a, 236a, 238a, (2) a flow diverter plate 218 including first, second, third, and fourth chambers 232b, 234b, 236b, 238b, and first, second, third, and fourth channels 240, 242, 244, 246, (3) a spray former plate 220 including first and second spray former plate portions 220a, 220b, and first and second pluralities of nozzles 248, 250, (4) a front plate 222 including third and fourth pluralities of nozzles 252, 254, and first and second pluralities of openings 256, 258, and (5) a spray face 208 including first, second, third, and fourth pluralities of openings 260, 262, 264, 266. However, one of ordinary skill in the art will appreciate that the shower head 200 could have: (1) a rear plate 216 with more or less than eight openings and seven chambers, (2) a flow diverter plate 218 with more or less than seven chambers and four channels, (3) a spray former plate 220 with more or less than two spray former plate portions and two pluralities of nozzles, (4) a front plate 222 with more or less than two pluralities of nozzles and two pluralities of openings, and (5) a spray face 208 with more or less than four pluralities of openings.

The exemplary embodiments of the present invention described above have at least one component that is unitarily formed. Additionally, some of the exemplary embodiments of the present invention described above have components that are concurrently formed.

In exemplary embodiments of the side spray 100, the waterway 102, 102′ is unitarily formed. In exemplary embodiments of the side spray 100, the spray face 106, 106′, 106″ is unitarily formed. In exemplary embodiments of the side spray 100, the spray face 106, 106′, 106″, including the body 166″ and the plurality of nozzles 168″, is unitarily formed. In the exemplary embodiments, at least a portion of the body 166″ is concurrently formed with the plurality of nozzles 168″.

In an exemplary embodiment of the shower head 200, the spray assembly 206, including the rear plate 216, the flow diverter plate 218, the spray former plate 220, and the front plate 222, is unitarily formed. In the exemplary embodiment, at least a portion of the spray former plate 220 is concurrently formed with at least a portion of the front plate 222. In an exemplary embodiment of the shower head 200, the spray assembly 206, including the rear plate 216, the flow diverter plate 218, the spray former plate 220, and the front plate 222, is unitarily formed. In the exemplary embodiment, at least a portion of the turbine 268 is concurrently formed with at least a portion of the spray former plate 220 and at least a portion of the front plate 222. In the exemplary embodiment, the turbine 268 is formed within the spray assembly 206.

In all of these exemplary embodiments, the component is unitarily formed or the components are concurrently formed using additive manufacturing. Additive manufacturing is also commonly referred to as rapid manufacturing and 3D printing.

One of ordinary skill in the art will now appreciate that the present invention provides spray devices for plumbing fixture fittings and unitarily formed components thereof having complex flow paths, made of multiple materials, and/or that are movable. Although the present invention has been shown and described with reference to particular embodiments, equivalent alterations and modifications will occur to those skilled in the art upon reading and understanding this specification. The present invention includes all such equivalent alterations and modifications and is limited only by the scope of the following claims in light of their full scope of equivalents.

What is claimed is:

1. A spray device for a plumbing fixture fitting, comprising:
a waterway, the waterway having an outer surface, the waterway including an inlet port, a first cavity, a first flow path, a first outlet port, a second cavity, a second flow path, and a second outlet port, the inlet port having an inlet opening in the outer surface, the inlet port being in fluid communication with the first cavity and the second cavity, the first cavity having a first cavity opening in the outer surface, the first cavity being in fluid communication with the first flow path, the second cavity having a second cavity opening in the outer surface, the second cavity being in fluid communication with the second flow path, the first flow path being in fluid communication with the first outlet port, the first outlet port having a first outlet opening in the outer surface, the second flow path being in fluid communication with the second outlet port, the second outlet port having a second outlet opening in the outer surface, the first flow path not being in fluid communication with the second flow path, the waterway being operable to have fluid flow from the inlet port to the first outlet port and the second outlet port;
a shell, the shell being hollow, the shell having an inlet opening, an actuator opening, and an outlet opening;
a spray face, the spray face including a first spray portion and a second spray portion, the first outlet port being in fluid communication with the first spray portion, the second outlet port being in fluid communication with the second spray portion;
a first valve body, the first valve body being operable to control fluid flow from the inlet port to the first outlet port;
a second valve body, the second valve body being operable to control fluid flow from the inlet port to the second outlet port; and
an actuator, the actuator being operable to connect to the first valve body and the second valve body through the actuator opening;
wherein the shell is operable to receive the waterway;
wherein the first cavity in the waterway is operable to receive the first valve body through the first cavity opening, and the second cavity in the waterway is operable to receive the second valve body through the second cavity opening;
wherein the first valve body is operable to move within the first cavity, and the second valve body is operable to move within the second cavity;
wherein the actuator is operable to move the first valve body within the first cavity, and the actuator is operable to move the second valve body within the second cavity;
wherein movement of the first valve body within the first cavity opens and closes fluid flow between the inlet port and the first outlet port, and movement of the second valve body within the second cavity opens and closes fluid flow between the inlet port and the second outlet;
wherein the first cavity opening has a central tangent line that passes through a center point of the first cavity opening and is tangent to a central longitudinal axis of the first flow path;
wherein the first outlet opening has a central tangent line that passes through a center point of the first outlet opening and is tangent to the central longitudinal axis of the first flow path;
wherein the first flow path includes a portion that is not parallel to and not tangent to at least one of the central tangent line of the first cavity opening and the central tangent line of the first outlet opening;
wherein the central tangent line of the first cavity opening is not parallel to the central tangent line of the first outlet opening; and
wherein the waterway is unitarily formed.

2. The spray device for the plumbing fixture fitting of claim 1, wherein the waterway is unitarily formed using additive manufacturing.

3. A spray device for a plumbing fixture fitting, comprising:
a waterway, the waterway having an outer surface, the waterway including an inlet port, a flow path, a cavity, and an outlet port, the inlet port having an inlet opening in the outer surface, the inlet port being in fluid communication with the flow path, the flow path being in fluid communication with the cavity, the cavity having a cavity opening in the outer surface, the flow path being in fluid communication with the outlet port, the outlet port having an outlet opening in the outer surface, the waterway being operable to have fluid flow from the inlet port to the outlet port;
a shell, the shell being hollow, the shell having an inlet opening, an actuator opening, and an outlet opening;
a spray face, the spray face including a spray portion, the outlet port being in fluid communication with the spray portion;
a valve body, the valve body being operable to control fluid flow from the inlet port to the outlet port; and
an actuator, the actuator being operable to connect to the valve body through the actuator opening;
wherein the shell is operable to receive the waterway;
wherein the cavity in the waterway is operable to receive the valve body through the cavity opening;
wherein the valve body is operable to move within the cavity;
wherein the actuator is operable to move the valve body within the cavity;
wherein movement of the valve body within the cavity opens and closes fluid flow between the inlet port and the outlet port;
wherein the spray portion has an outer surface, the spray portion includes an inlet port, a flow path, and an outlet port, the inlet port has an inlet opening in the outer surface, the flow path extends from the inlet port to the outlet port, the outlet port has an outlet opening in the outer surface, the outlet port has a central longitudinal axis that passes through a center point of the outlet opening, the outlet port is converging, and at least one of the flow path from the inlet port to the outlet port includes an obstruction and the central longitudinal axis of the outlet port does not pass through the inlet opening; and
wherein the spray face is unitarily formed.

4. The spray device for the plumbing fixture fitting of claim 3, wherein the spray face is unitarily formed using additive manufacturing.

5. A spray device for a plumbing fixture fitting, comprising:
a waterway, the waterway having an outer surface, the waterway including an inlet port, a flow path, a cavity, and an outlet port, the inlet port having an inlet opening in the outer surface, the inlet port being in fluid communication with the flow path, the flow path being in fluid communication with the cavity, the cavity having a cavity opening in the outer surface, the flow path being in fluid communication with the outlet port, the outlet port having an outlet opening in the outer surface, the waterway being operable to have fluid flow from the inlet port to the outlet port;
a shell, the shell being hollow, the shell having an inlet opening, an actuator opening, and an outlet opening;
a spray face, the spray face including a spray portion, the outlet port being in fluid communication with the spray portion;
a valve body, the valve body being operable to control fluid flow from the inlet port to the outlet port; and
an actuator, the actuator being operable to connect to the valve body through the actuator opening;
wherein the shell is operable to receive the waterway;
wherein the cavity in the waterway is operable to receive the valve body through the cavity opening;
wherein the valve body is operable to move within the cavity;
wherein the actuator is operable to move the valve body within the cavity;
wherein movement of the valve body within the cavity opens and closes fluid flow between the inlet port and the outlet port;
wherein the spray portion includes a body and a nozzle, the body is formed from a first material, the nozzle is formed from a second material, and the first material is different than the second material; and
wherein the spray face, including the body and the nozzle, is unitarily formed, and at least a portion of the body is concurrently formed with the nozzle.

6. The spray device for the plumbing fixture fitting of claim 5, wherein the spray face, including the body and the nozzle, is unitarily formed and the portion of the body is concurrently formed with the nozzle using additive manufacturing.

7. A spray device for a plumbing fixture fitting, comprising:
a manifold, the manifold including an inlet and an outlet, the inlet being in fluid communication with the outlet;
a spray assembly, the spray assembly including a rear plate, a flow diverter plate, a spray former plate, and a front plate;
the rear plate including a first opening, a first chamber, a second opening, and a second chamber, the first opening being operable to fluidly communicate with the outlet of the manifold, the first opening being in fluid communication with the first chamber, the second opening being operable to fluidly communicate with the outlet of the manifold, the second opening being in fluid communication with the second chamber;
the flow diverter plate including a first channel and a second channel, the first channel being in fluid communication with the first chamber, the second channel being in fluid communication with the second chamber;
the spray former plate including a plurality of nozzles, the nozzles of the spray former plate being in fluid communication with one of the first channel and the second channel; and
the front plate including a plurality of nozzles and a plurality of openings, the nozzles of the front plate being in fluid communication with the other of the first channel and the second channel, the openings of the front plate being operable to receive the nozzles of the spray former plate; and
a spray face, the spray face including a plurality of openings, the openings in the spray face being operable to receive the nozzles of the spray former plate and the nozzles of the front plate;
wherein the spray former plate is formed from a first material, the front plate is formed from a second material, and the first material is different than the second material; and
wherein the spray assembly, including the rear plate, the flow diverter plate, the spray former plate, and the front plate, is unitarily formed, and at least a portion of the spray former plate is concurrently formed with at least a portion of the front plate.

8. The spray device for the plumbing fixture fitting of claim 7, wherein the spray assembly, including the rear plate, the flow diverter plate, the spray former plate, and the front plate, is unitarily formed and the portion of the spray former plate is concurrently formed with the portion of the front plate using additive manufacturing.

9. A spray device for a plumbing fixture fitting, comprising:
a manifold, the manifold including an inlet and an outlet, the inlet being in fluid communication with the outlet;
a spray assembly, the spray assembly including a rear plate, a flow diverter plate, a turbine, a spray former plate, and a front plate;
the rear plate including a first opening, a first chamber, a second opening, and a second chamber, the first opening being operable to fluidly communicate with the outlet of the manifold, the first opening being in fluid communication with the first chamber, the second opening being operable to fluidly communicate with the outlet of the manifold, the second opening being in fluid communication with the second chamber;
the flow diverter plate including a first channel and a second channel, the first channel being in fluid communication with the first chamber, the second channel being in fluid communication with the second chamber;
the turbine including a plurality of vanes, the turbine being in fluid communication with one of the first channel and the second channel;
the spray former plate including a plurality of nozzles, the nozzles of the spray former plate being in fluid communication with the other of the first channel and the second channel; and
the front plate including a plurality of nozzles and a plurality of openings, the nozzles of the front plate being in fluid communication with the turbine, the openings of the front plate being operable to receive the nozzles of the spray former plate; and
a spray face, the spray face including a plurality of openings, the openings in the spray face being operable to receive the nozzles of the spray former plate and the nozzles of the front plate;
wherein the turbine is operable to rotate within the spray assembly; and
wherein the spray assembly, including the rear plate, the flow diverter plate, the spray former plate, and the front plate, is unitarily formed, and at least a portion of the turbine is concurrently formed with at least a portion of the spray former plate and at least a portion of the front plate.

10. The spray device for the plumbing fixture fitting of claim 9, wherein the spray assembly, including the rear plate, the flow diverter plate, the turbine, the spray former plate, and the front plate, is unitarily formed and the portion of the turbine is concurrently formed with the portion of the spray former plate and the portion of the front plate using additive manufacturing.

11. A waterway for a spray device for a plumbing fixture fitting, comprising:
an inlet port, the inlet port having an inlet opening in an outer surface of the waterway;
a first cavity, the inlet port being in fluid communication with the first cavity, the first cavity having a first cavity opening in the outer surface;
a first flow path, the first cavity being in fluid communication with the first flow path;
a first outlet port, the first flow path being in fluid communication with the first outlet port, the first outlet port having a first outlet opening in the outer surface;
a second cavity, the inlet port being in fluid communication with the second cavity, the second cavity having a second cavity opening in the outer surface;
a second flow path, the second cavity being in fluid communication with the second flow path, the first flow path not being in fluid communication with the second flow path; and
a second outlet port, the second flow path being in fluid communication with the second outlet port, the second outlet port having a second outlet opening in the outer surface;
wherein the waterway is operable to have fluid flow from the inlet port to the first outlet port and the second outlet port;
wherein the first cavity opening has a central tangent line that passes through a center point of the first cavity opening and is tangent to a central longitudinal axis of the first flow path;
wherein the first outlet opening has a central tangent line that passes through a center point of the first outlet opening and is tangent to the central longitudinal axis of the first flow path;
wherein the first flow path includes a portion that is not parallel to and not tangent to at least one of the central tangent line of the first cavity opening and the central tangent line of the first outlet opening;
wherein the central tangent line of the first cavity opening is not parallel to the central tangent line of the first outlet opening; and
wherein the waterway is unitarily formed.

12. The waterway for the spray device for the plumbing fixture fitting of claim 11, wherein the waterway is unitarily formed using additive manufacturing.

13. A spray face for a spray device for a plumbing fixture fitting, comprising:
a spray portion, the spray portion having an outer surface;
the spray portion including:
an inlet port, the inlet port having an inlet opening in the outer surface;
a flow path, the flow path extending from the inlet port to the outlet port; and
an outlet port, the outlet port having an outlet opening in the outer surface, the outlet port having a central longitudinal axis that passes through a center point of the outlet opening;
wherein the outlet port is converging;
wherein at least one of the flow path from the inlet port to the outlet port includes an obstruction and the central longitudinal axis of the outlet port does not pass through the inlet opening; and
wherein the spray face is unitarily formed.

14. The spray face for the spray device for the plumbing fixture fitting of claim 13, wherein the spray face is unitarily formed using additive manufacturing.

15. A spray face for a spray device for a plumbing fixture fitting, comprising:
a spray portion;
the spray portion including:
a body, the body is formed from a first material; and
a nozzle, the nozzle is formed from a second material;
wherein the first material is different than the second material;
wherein the spray face, including the body and the nozzle, is unitarily formed; and
wherein at least a portion of the body is concurrently formed with the nozzle.

16. The spray face for the spray device for the plumbing fixture fitting of claim 15, wherein the spray face, including the body and the nozzle, is unitarily formed and the portion of the body is concurrently formed with the nozzle using additive manufacturing.
